(19) United States
(12) Patent Application Publication
(10) Pub. No.: US 2006/0031125 A1
(43) Pub. Date: Feb. 9, 2006

(54) Interactive forms processing system and method

(75) Inventors: Alex Zilberfayn, San Carlos, CA (US); Tania Wasser, San Carlos, CA (US)

Correspondence Address: KAPLAN GILMAN GIBSON & DERNIER L.L.P., 900 ROUTE 9 NORTH, WOODBRIDGE, NJ, 07095, US

(73) Assignee: Intresys

(21) Appl. No.: 11/165,878

(22) Filed: Jun. 24, 2005

Related U.S. Application Data
(63) Continuation-in-part of application No. 11/014,283, filed on Dec. 16, 2004.
(60) Provisional application No. 60/529,989, filed on Dec. 16, 2003.

(51) Int. Cl. G06Q 30/00

(52) U.S. Cl. 705/26

(57) ABSTRACT

A system and method for assisting self-represented litigants, their agents, or attorneys in completing legal forms for a variety of issues, namely, an interactive forms processing system and method comprising a rules-based, on-line question and answer session that determines the form or forms needed for a particular application, completes those forms consistently and accurately, and allows them to be printed and/or optionally filed in the appropriate court, over a wide area network such as the Internet or other TCP/IP transport.

### CROSS REFERENCE TO RELATED APPLICATIONS

This application is a continuation-in-part of U.S. patent application Ser. No. 11/014,283 filed Dec. 16, 2004, entitled “INTERACTIVE FORMS PROCESSING SYSTEM AND METHOD,” which claims the benefit of U.S. Provisional Patent Application No. 60/529,989, filed Dec. 16, 2003, entitled “INTERACTIVE FORMS PROCESSING SYSTEM AND METHOD. All of the disclosures of which are hereby incorporated herein by reference.

### TECHNICAL FIELD

The present invention relates to systems and methods for processing forms and in particular to systems and methods for assisting self-represented litigants and attorneys complete legal forms.

### BACKGROUND OF THE INVENTION

Each year thousands of individuals are required to institute legal proceedings in some form or another. Unfortunately, many such individuals do not have the financial ability to retain an attorney to act on their behalf. In other cases, individuals conclude they do not require an attorney to represent them. In either case, it is necessary for these individuals to proceed on a pro se basis.

For the most part every court has its own procedures, forms and processes that it uses to conduct business. In addition, most courts have different forms and procedures depending on the type of legal proceeding at issue, i.e., a particular court will typically have different forms that are used for family court filings than are used for eviction proceedings, and so on. Often, even when the correct form is identified by an applicant, instructions for form completion are vague, nonexistent or difficult to understand, making form completion difficult. In addition, courts often have different requirements for payment of fees in terms of amount and in terms of the fees that must accompany particular filings.

As a result, pro se applicants are faced with the daunting prospect of myriad forms and procedures when beginning, continuing or responding to the legal process, inevitably resulting in confusion and uncertainty. Accordingly, there is a need for a system that provides pro se litigants/applicants with a convenient and easy to understand procedure for completing the forms appropriate for a given situation and filing the forms in court. It would be desirable to provide a system in which an applicant would not need to see the form until it was completed. Such a system could be used by legal professionals as well.

### SUMMARY OF THE INVENTION

The invention comprises a system and method for assisting self-represented litigants, their agents, or attorneys in completing legal forms for a variety of issues. In particular, the present invention provides an interactive forms processing system and method comprising a rules-based, on-line question and answer session that determines the form or forms needed for a particular application, completes those forms consistently and accurately, and allows them to be printed and/or optionally filed in the appropriate court, over a wide area network such as the Internet or other TCP/IP transport.

In other aspects of the present invention forms are prepared based on the rules and procedures of the court to comply with the acceptance and processing statues or rules of a given court.

In another embodiment a system in accordance with the present invention is adapted to generate attachments in circumstances where a given form to be populated does not permit entry of data or allow sufficient space for entry of all information.

In another embodiment the present invention provides data element validation and error checking preventing the entry of impossible or inconsistent data, such as but not limited to erroneous information such as a marriage date in the future, a birth date in the future, etc.

Self-help center PCs or kiosks may also be employed. The present invention permits courts of all sizes to be more responsive and cost-efficient in handling pro-se filings. The present invention provides options to print the forms or e-deliver them directly to the court, allowing users to access the applications from any computer connected to the Internet or other TCP/IP transport. The invention enables courts to receive complete and accurate information right from the start of the filing process, leading to significant time savings at all stages, from initial to subsequent filing to court hearing, post hearing and order enforcement. The present invention can be employed in connection with any type of legal proceeding including but not limited to Family Law proceedings including Divorce, Separation, Child Custody, Child Support, Spousal Support, Visitation, Paternity, and corresponding Responses; Small Claims proceedings including Plaintiff's Claim, Defendant's Counter-Claim; Landlord-Tenant proceedings including Eviction and Defendant's Response to Eviction; and Guardianship Probate including permanent and/or Temporary Guardianship of Minors and their Estates; Domestic Violence filings for injunctions, temporary restraining orders, extensions and terminations. The present invention relieves Customers from having to complete a complex series of interrelated forms, alleviates the burden on counter staff being tied up by assisting customers in this task, which typically averages 40 minutes to 2 hours per encounter and eliminates the possibility of placing court personnel in a position where they may be considered to be providing legal advice or not maintaining court's impartiality. It has been shown that the present invention reduced the assistance time required for customers an average of 55%.

One embodiment of the present invention executes on a web client that is connected to a computer network such as the Internet. The web client, a standard browser such as Internet Explorer, Netscape Navigator or Mozzilla FireFox is capable of obtaining web pages that contain questionnaires from a web server. The web server contains computer code configured to accept a web user's responses to a questionnaire and use the responses to select the appropriate court and the appropriate court form(s) and populate the form(s) with the information contained in the user's responses or generated by the system based on the data input. The completed form(s) can then be printed by the web client for subsequent filing in the appropriate court. In another embodiment, the web server contains communication software that enables the web client to file the completed form(s), attached documents and any filing or other appropriate fees with the appropriate court via the network.

In yet a further embodiment, a method is provided in which payment can be made in cash using a PIN or other identifier.

In a preferred embodiment, the information provided by a web user is stored on the web server for later use by the web client.

### BRIEF DESCRIPTION OF THE DRAWINGS

FIG. 1 discloses one embodiment of a system according to the present invention.

FIG. 2 depicts a method in accordance with at least one aspect of the present invention.

FIG. 3 depicts a process flow diagram in accordance with at least one aspect of the present invention.

FIG. 4 depicts a process flow in accordance with at least one aspect of the present invention.

FIG. 5 depicts a process flow in accordance with at least one aspect of the present invention.

FIG. 6 depicts a process flow for payment in accordance with at least one aspect of the present invention.

FIG. 7 depicts a process flow in accordance with at least one aspect of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

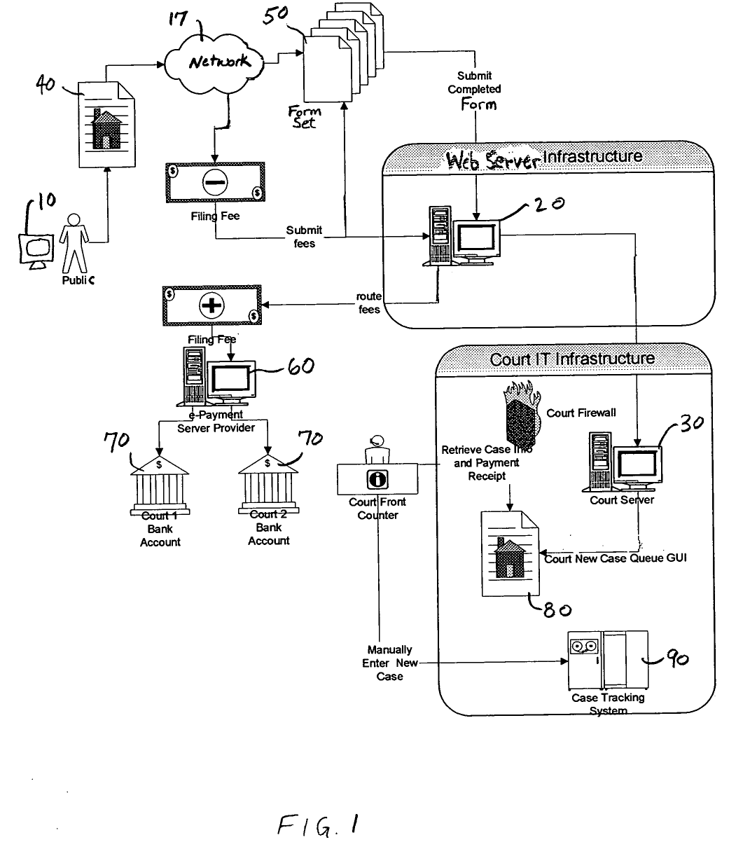

Now referring to FIG. 1 a system in accordance with one embodiment of the present invention comprises web server 20, accessible via a client computer 10, and optionally a court server 30 connected via a wide area network such as the Internet. In accordance with the present invention a client desiring to initiate or submit papers in connection with a litigation accesses a web page 40 via client computer 10 or other suitable device to begin the process of completing a legal form 50. A client is typically a pro se litigant or attorney. Web page 40 may comprise plural pages containing a questionnaire that is completed by the client. In one embodiment web page 40 presents a client with a query requesting the state in which the litigation is to be conducted. Upon receiving the entry by the client, a software program, preferably residing on the web server 20, presents a new web page 40 requesting the specific location of the court in the identified state. Court locations for the selected state are preferably presented to the client in the form of a drop down menu, interactive map or other suitable means. Upon receiving the entry for the location, web sever 20 presents a new web page to the client requesting entry of the type of matter to which the litigation relates such as but not limited to Family Law proceedings including Divorce, Separation, Child Custody, Child Support, Spousal Support, Visitation, Paternity, and corresponding Responses; Small Claims proceedings including Plaintiff's Claim, Defendant's Counter-Claim; Landlord-Tenant proceedings including Eviction and Defendant's Response to Eviction; and Guardianship Probate including permanent and/or Temporary Guardianship of Minors and their Estates; Domestic Violence filings for injunctions, temporary restraining orders, extensions and terminations and the like. Based on the type of proceeding selected by the client, the web server 20 presents a web page 40 containing a customized questionnaire adapted to populate the appropriate legal form(s) 50 for the particular action selected by the client. A database containing the information necessary for software controlling the transaction to identify the proper form(s) 50, e.g., form identification data and the like, is preferably resident on web server 20. Once the questionnaire is completed, the web server 20 generates a completed forms set that can be downloaded by client computer 10 via Adobe Acrobat PDF viewer or the like. In one embodiment the client can print the completed form(s) 50 and file the form(s) 50 manually in the appropriate court and pay any fee required such as a filing fee at that time.

Examples of web pages 40 in accordance with the present invention are accessible to a client at the website www.TurboCourt.com, the entire content of which is incorporated herein by reference.

Alternatively, web server 20 presents a web page 40 to the client requesting whether the client wishes to file the form electronically. Upon request, web server 20 executes filing of the completed form 50 directly to court server 30. In one embodiment the system further comprises an electronic payment server 60 provider enabling a client to submit any filing fees appropriate for a given form. Payment is preferably routed to the location 70 identified by the court for receiving filing fees.

Alternatively fees can be routed to the court itself. An example of an electronic payment server includes a server operated by PayPal®. Regardless of the manner in which filings are made, i.e., manually or electronically, the case is preferably entered in a court case queue 80 and preferably entered in a court tracking system 90.

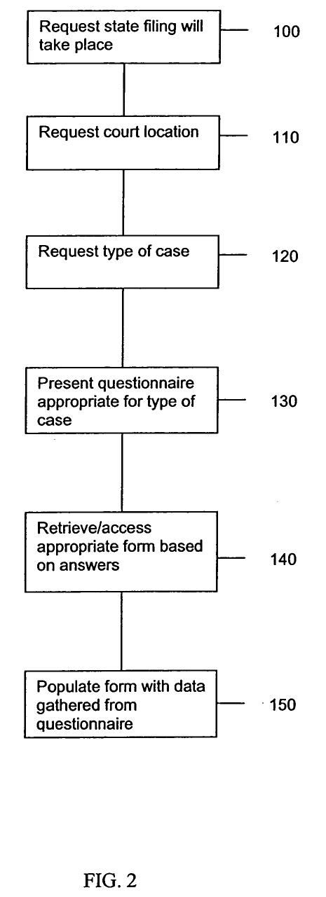

Now referring to FIG. 2, software in accordance with the present invention executes the steps of requesting the state in which a particular filing is to take place in step 100, requesting the specific location of the court or jurisdiction in which the case is to be filed in step 110, requesting the type of case to be filed in step 120, presenting to the client a questionnaire appropriate for the type of case identified in step 130, accessing the appropriate form from a database based on the answers provided in response to the questionnaire in step 140, and populating the form with the data gathered from the client via the questionnaire in step 150. In this way the client does not see the form until it is completed. It will be understood by those skilled in the art that software in accordance with the present invention may be written in XML, Java, HTML, C++ or any appropriate programming language suitable for the present invention. Preferably software in accordance with the present invention is written in XML, Java.

In other aspects of the present invention forms are prepared based on the rules and procedures of the court to comply with the acceptance and processing statues or rules of a given court.

In another embodiment a system in accordance with the present invention is adapted to generate attachments in circumstances where a given form to be populated does not permit entry of data or allow sufficient space for entry of all information. For example, a given form may allow enough space to enter 2 children names; in this event, a system in accordance with the present invention will generate an attachment containing overflow information, i.e., any additional children names beyond what will fit in the two spaces allotted, from the form having the insufficient space. The attachment preferably contains a reference to the form to which it is related.

In another embodiment the present invention provides data element validation and error checking preventing the entry of impossible or inconsistent data, such as but not limited to erroneous information such as a marriage date in the future, a birth date in the future, etc. In one embodiment upon completion of the questionnaire the client is asked to “Validate Form” and the system checks the questionnaire for impossible or inconsistent data. The client is asked to re-enter information to overcome the inconsistency or impossibility. In yet another embodiment, the data element validation and error checking is performed automatically, wherein for example if a client enters inconsistent information the system presents an error message noting the inconsistency.

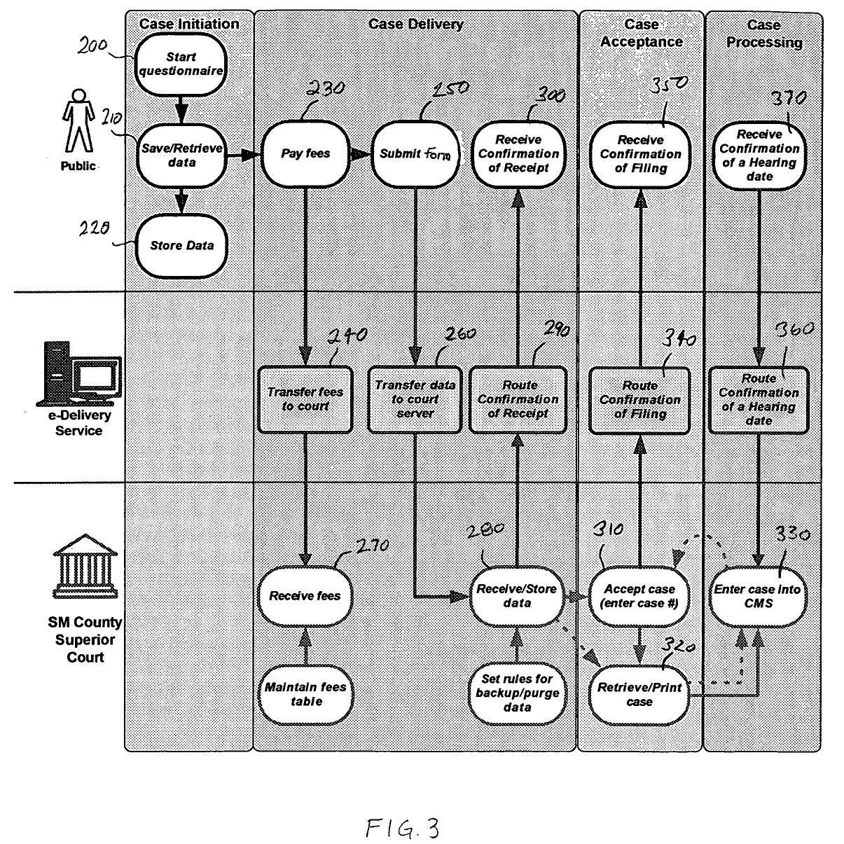

Now referring to FIG. 3, in another embodiment a method is depicted employing a court maintained website. After logging onto a court maintained website, in the case initiation phase the client starts 200 the questionnaire, saves or retrieves 210 the data, depending on whether the client has already begun the questionnaire and is returning to it or is starting a new filing, and optionally stores 220 the data for later retrieval. In the case delivery phase, the client submits 250 to the court electronically the form generated as a result of completion of the questionnaire, which form is transferred 260 to a court server, and the client pays 230 the appropriate fees wherein the fees are transferred 240 to the court electronically. Receipts for fees and form filing are generated and sent 270, 280, 290, 300 to the client computer. In the case acceptance phase, the case submitted to the court server and routed to the court database is accepted 310 and a case number is assigned, and/or is printed and manually entered 320, 330 in the court case management system. Upon assignment of a case number, confirmation of filing is routed 340, 350 to the client. In the case processing phase, after entering the case management system, the court routes confirmation of a hearing date, if appropriate, to the client 360, 370.

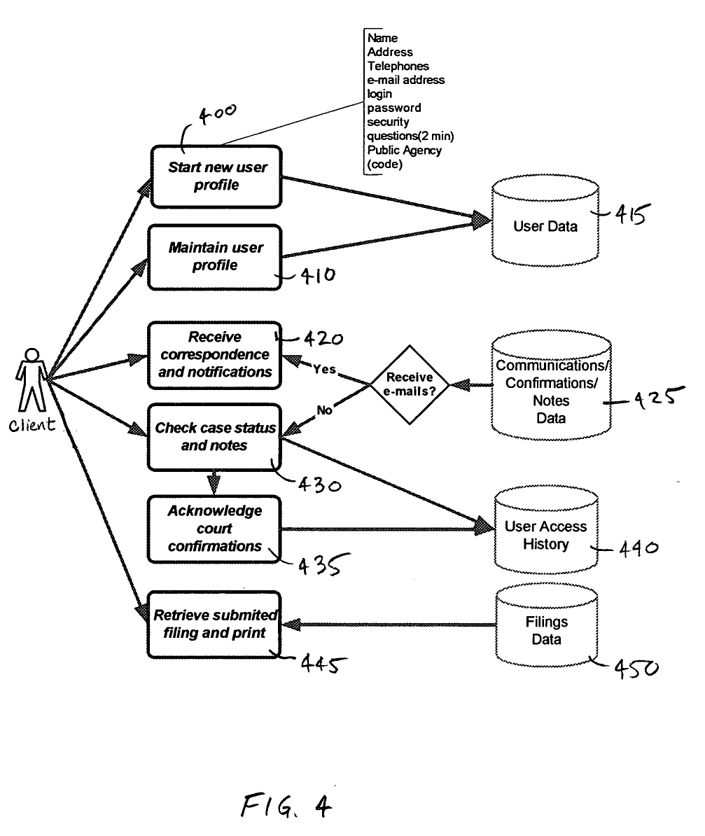

Now referring to FIG. 4 in one embodiment web pages according to the present invention provide a client with several options when accessing a web server, including creating 400 a new user profile, wherein a client is requested to provide data such as but not limited to name, address, telephone number, e-mail address, log in information such as password and security questions and whether the client is a public entity. The data is stored in a user data database 415. Maintaining 410 a user profile permits a client to change or add user data. Clients are enabled through the web page to receive correspondence and notifications 420, where a client elects to receive emails from the server containing communications and confirmation data 425, check case status and notes 430 including acknowledgement 435 of court confirmations stored in the user access history database 440 and retrieve and print 445 submitted forms stored in a filings data database 450.

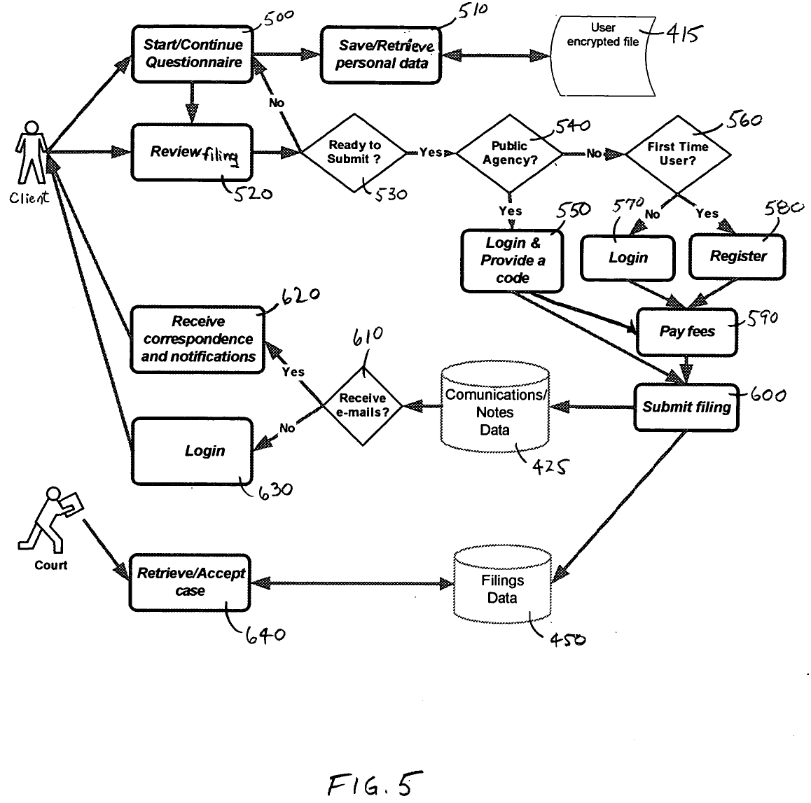

Now referring to FIG. 5, in one embodiment a client accesses a server via a website (not shown) and chooses to either start or continue a questionnaire 500 or review a filing 520. Client saves or retrieves 510 personal data from user file 415, preferably encrypted in accordance with encryption methods known to those having skill in the art. Upon completion of the questionnaire, the client is offered the opportunity to review 520 the filing and asked whether the client is ready 530 to submit the populated form. If not, the client returns to the questionnaire step 500. In one embodiment, a system in accordance with the present invention provides different fee structures for different types of clients. For example, in one embodiment at the step 530 where the client is ready to submit the form, the system asks the client if it is a public agency in step 540; if so, the system requests the agency to log in 550 and optionally provide a code identifying the filer as a public agency. In such an event the public agency may or may not be required to pay a fee, or may be entitled to pay a reduced fee. If the client is not a public agency, the system queries the client whether it is a first time user 560; if so, the client is requested to register 580 and provide new user identification information such as user name and password; if not, the client can log in 570 using previously registered user identification information. The client then accesses a fee payment area 590 of the website and submits the filing 600. The filing is stored in the filings data database 450 and forwarded to the court where it is retrieved and accepted or rejected 640. The filing is also stored in the communications/notes database 425. As will be apparent to one skilled in the art a confirmation number or other identifier may be associated with a filing. If the client has previously requested that it receive e-mail communications 610, e-mail correspondence such as confirmation of filing will be transmitted 620 to the client. If the client has not elected to receive e-mail correspondence, the client can log in 630 to the website to review filing information 520.

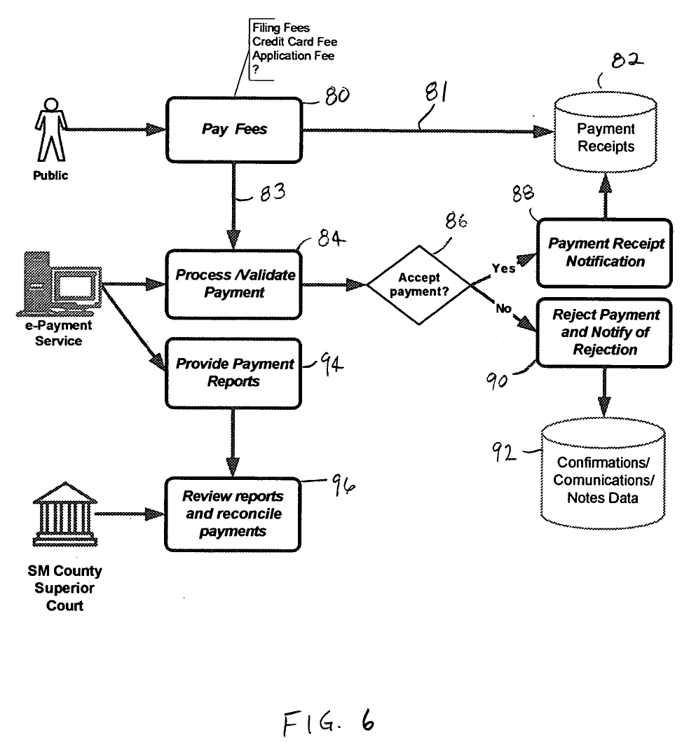

Now referring to FIG. 6, methods of payment in accordance with the present invention are depicted. A client pays fees 80 either manually 81 or electronically 83 through an electronic payment service which processes and validates payment 84 and indicates whether payment is accepted 86 and issues a receipt 82. The client is then advised whether payment was successful 88, 90, 92. The electronic payment service provides payment reports 94 to the system so the court can review and reconcile 96 such payments with client filings.

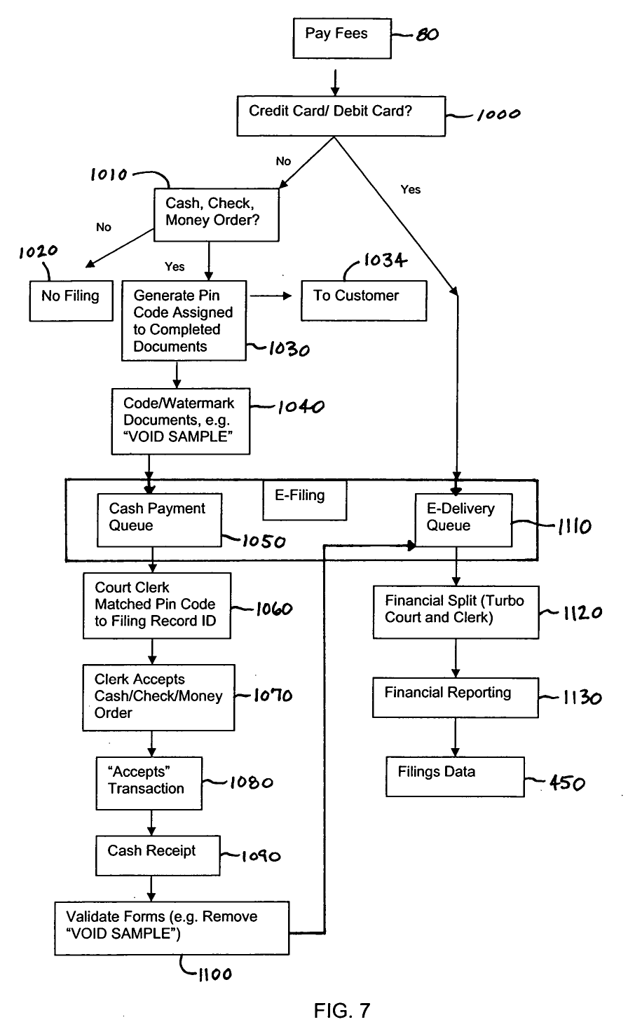

In an alternate embodiment, a system in accordance with the present invention provides a client means for accepting cash as at least one mode of payment. That is, in addition to, or alternative to, credit or debit card payment, a user may pay fees with cash, check or money order in accordance with one aspect of the present invention. Now referring to FIG. 7, an embodiment in which a client is permitted to pay with cash or other non-credit or debit form of currency is depicted. A client paying via credit card in step 1000 is routed to an e-delivery queue 1110 for subsequent financial processing, such as but not limited to, a financial split process in which fees are divided appropriately between the clerk of court and the electronic filing server (1120); financial reporting (1130) for court records and the like and recording filings data and filing data in database 450 for subsequent review by the court.

In step 1010, a client is provided with an option to pay by cash, check, money order or other form of payment. If the client elects not to pay, then no filing occurs (1020). If a client elects to pay by cash, check, money order or other means, an identifier such as but not limited to a PIN code is generated and assigned to the completed documents in step 1030. The identifier is forwarded, preferably via e-mail, to the customer in step 1034. Completed documents are coded, such as by watermark or other means in 1040 to identify the documents as being void, i.e., not ready for filing. This is desirable because in some embodiments the completed documents may be printed out and filed by hand by the client. The watermark or code on the document prevents the client from filing without paying. Coded documents are forwarded to a cash payment queue 1050 where the identifier is matched to a filing record identification (such as a confirmation number) linking the identifier to the previously prepared documents in step 1060. In step 1070, the clerk accepts payment in the form of cash, check or money order and accepts the transaction in step 1080. A cash receipt is provided to the client in step 1090 and in step 1100, the documents are validated, that is any coding or watermark placed on the documents is removed and the documents can be forwarded to the e-delivery queue 1110.

It is to be understood that the coding step in which documents are identified as not ready to be filed for lack of payment may be performed in a number of different ways. For example, documents for which a filing fee has not yet been received may bear no mark at all, and upon payment may be marked with a code such as a paid stamp, electronic watermark or the like.

It will also be understood that the foregoing payment may be applied in other e-commerce applications. For example, virtually any transaction that can be performed via electronic payment, such as by credit card, may be carried out in accordance with the foregoing method. For example, individuals wishing to purchase goods such as books, appliances, automobiles and any other articles of commerce, can simply submit their order on line, elect to pay with cash or an equivalent, in response to which a unique identifier such as a PIN code can be assigned to the transaction, the identifier can be transmitted to a customer electronically or via other means such as mail, telephone message or the like and optionally, a document may be generated which the client can print for presentation at a site of pick up of the ordered merchandise, or at some other location where a cash transaction can be effected. Once the identifier is generated, the order can be transmitted to a cash payment queue. When a client arrives at a location to complete the cash transaction, the client provides the identifier that is matched to an order identification such as but not limited to a confirmation number, makes payment and the transaction is closed and the merchandise is presented to the client.

As will be apparent to those having skill in the art, the same processes and steps can be employed in order to purchase services via a network.

Preferred embodiments of the instant invention operate on a network, such as, for example, the Internet, or another type of remote access system, such as a kiosk-based terminal, a telephone, a personal digital assistant, a pulse code system, web TV, or any other device or method that communicates alpha numeric data through a server.

Preferred embodiments of the instant invention operate in accordance with a plurality of networked computers, such as, for example, a user computer and a server computer which are coupled together on a communications network, such as, for example, the Internet or a wide area network. Network communication hardware that operates to implement preferred embodiments of the invention includes a server computer 20 and a client computer terminal 10, wherein server computer 20 and user computer 10 are in electronic communication with each other via a network 17. Network 17 may be a local area network (LAN), a wide area network (WAN), or the Internet, and is hardwired, wireless, or a hybrid thereof.

In some preferred embodiments, network communication hardware 10 includes a plurality of either servers, client computers, or any combination thereof. Server 20 incorporates a memory device from which information and other relevant data is accessible to client computer 10. It will be understood that network systems in accordance with various embodiments can include more than two servers 20.

Server computer 20 comprises any suitable network-connectable device capable of providing content (data representing text, hypertext, photographs, graphics, video and/or audio) for communication over network 17. In preferred embodiments, server computer 20 is a programmable processor capable of operating in accordance with programs stored on one or more of computer readable media (for example, but not limited to, floppy disks, hard disks, random access memory RAM, CD-ROM, ZIP disks), to provide content for communication to a connected client computer 10. Server computer 20 comprises, for example, but is not limited to, a personal computer, a mainframe computer, network computer, portable computer, personal digital assistant (such as, a 3Com Palm Pilot), or the like. The server computer 20 may include one or more internal data storage devices, e.g. a hard drive (not shown), for storing content for communication to a client computer 10. Alternatively, or in addition, server computer 20 is coupled to an external data storage device, computer or other means, from which server computer 20 obtains information for communication to client computer 10. In one embodiment, such external device comprises at least one further network device coupled to network 17. Server computer 20 is controlled by suitable software to provide requested content information to the requesting client computer 10, provided that various criteria are met.

In a preferred WAN environment, such as the Internet, server computer 20 is controlled by software adapted to generate a response to a valid request for content information by transmitting or downloading data in the form of one or more HTML files to a requesting client computer 10. It will be understood by those skilled in the art that this process involves communication through routers and other network components in addition to suitable servers, as is dictated by the particular network environment.

Client computer 10 comprises any suitable network-adapted device capable of communicating with other devices in the network system according to an established protocol. In preferred embodiments, client computer 10 comprises a programmable processor capable of operating in accordance with programs stored on one or more computer readable media (for example, but not limited to floppy disk, hard disk, computer network, random access memory (RAM), CD Rom, ZIP disks, or the like). Client computer 10 also has a display device for providing a user-perceivable display (for example, but not limited to visual displays, such as cathode ray tube (CRT) displays, light-emitting-diode (LED) or liquid-crystal-diode (LCD) displays, plasma displays or the like, audio displays or tactile displays), and a user input device (for example, but not limited to, a keyboard, mouse, trackball, touch pad, microphone, or the like). In one preferred embodiment, client computer 10 comprises a personal computer system having a CRT display, a keyboard and a mouse user-input device.

The client computer 10 is controlled by suitable software, including network communication and browser software to allow a user to request, receive and display information (or content) from or through a server computer 20 on the network 17. The client computer 10 is any means capable of communicating with the server computer(s) 20, including, but not limited, to personal computers, PDAs, email-enabled cell phones and ATM-type terminals. Client computer 10 accesses server computer(s) 20 via network 17 or through some other remote access, such as, for example, by telephone lines.

While the preferred embodiments have been described and illustrated it will be understood that changes in details and obvious undisclosed variations might be made without departing from the spirit and principle of the invention and therefore the scope of the invention is not to be construed as limited to the preferred embodiment.

What is claimed is:

1. An interactive forms processing system comprising a web server, said web server operable to receive information from at least one remote computer via a wide area network, and use said information to populate at least one court-related form, said system further comprising a payment server and means for accepting forms of payment other than credit or debit account payment as at least one mode of payment.

2. The system according to claim 1 further comprising at least one court server.

3. The system according to claim 1 further comprising a means for identifying at least one populated form.

4. The system according to claim 1 comprising means for providing a user of the system a choice of payment modes.

5. The system according to claim 4 comprising means for generating an identifier code to be assigned to said form when a user elects to make payment other than by credit or debit account.

6. The system according to claim 5 comprising means for coding said form.

7. A method of providing in an interactive web site the option for users thereof to make payment for goods or services available on or through said website by non-credit and non-debit means.

8. The method according to claim 7 said non-credit and non-debit means comprising cash, check or money order.

9. The method according to claim 7 comprising the steps of:
offering at least one good or service via a wide area network;
providing to at least one user a non-credit and non-debit payment option;
accepting from said at least one user a selection of said at least one good or service to be
purchased;
assigning a unique identifier to said selection; and
transmitting said identifier to said user.

10. The method according to claim 9 comprising the further step of providing to said user said at least one good or service upon presentation by said user of said identifier and payment.

11. The method according to claim 10 said identifier comprising a personal identification number (PIN).

12. The method according to claim 6 comprising providing a watermark.

13. The system according to claim 6 comprising a means for validating a coded form.
